(19) United States
(12) Patent Application Publication
(10) Pub. No.: US 2008/0024919 A1
(43) Pub. Date: Jan. 31, 2008

(54) Freezing point reduction in FDB by enhancing lubricants with additives

(75) Inventor: Raquib U. Khan, Pleasanton, CA (US)

Correspondence Address: Seagate Technology;c/o DARBY & DARBY P.C., P.O. Box 770, Church Street Station, New York, NY, 10008-0770, US

(73) Assignee: SEAGATE TECHNOLOGY LLC, Scotts Valley, CA (US)

(21) Appl. No.: 11/706,265

(22) Filed: Feb. 15, 2007

Related U.S. Application Data
(63) Continuation of application No. 10/962,405, filed on Oct. 13, 2004.

(51) Int. Cl. G11B 15/64

(52) U.S. Cl. 360/234.1; 508/110

(57) ABSTRACT

An embodiment of the invention relates to a magnetic recording storage device having a lubricant and an acrylate-containing compound as a freezing and or pour point depressant additive for the lubricant. Yet another embodiment relates to a method of depressing the freezing point of lubricant of a spindle motor having obtaining a component of a magnetic recording storage device and depositing a lubricant and an acrylate-containing compound as a freezing and or pour point depressant additive for the lubricant on the component.

### RELATED APPLICATION

This application is related to U.S. patent application Ser. No. 10/962,405, filed Oct. 13, 2004, and U.S. patent application Ser. No. No. 10/912,561, filed Aug. 6, 2004, which are incorporated herein by reference.

### FIELD OF THE INVENTION

The present invention relates to a recording media having an advanced lubricant for thin film storage medium and fluid dynamic bearing (FDB) of a disk drive, for example.

### BACKGROUND

Magnetic discs with magnetizable media are used for data storage in most all computer systems. Current magnetic hard disc drives operate with the read-write heads only a few nanometers above the disc surface and at rather high speeds, typically a few meters per second. Because the read-write heads can contact the disc surface during operation, a layer of lubricant is coated on the disc surface to reduce wear and friction.

FIG. 1 shows a disk recording medium and a cross section of a disc showing the difference between longitudinal and perpendicular recording. Even though FIG. 1 shows one side of the non-magnetic disk, magnetic recording layers are sputter deposited on both sides of the non-magnetic aluminum substrate of FIG. 1. Also, even though FIG. 1 shows an aluminum substrate, other embodiments include a substrate made of glass, glass-ceramic, NiP/aluminum, metal alloys, plastic/polymer material, ceramic, glass-polymer, composite materials or other non-magnetic materials.

Lubricants in a disc drive are applied on the spindle motor as well as on the disc surface. A lubricant fluid such as oil is typically filled in the bearing space which is created in the gap between the bearing sleeve and the shaft bush. On the other hand, a lubricant is applied to the disc surface by dipping the disc in a bath containing the lubricant or spraying the lubricant to the disc surface.

The lubricant film on the spindle motor or hard discs provides protection to the underlying materials by preventing wear. In addition, it provides protection against corrosion of the underlying materials. Reliability of hard disk drive is depends on the durability of the spindle motor and thin film media. Lubrication plays unquestionably an important role.

### SUMMARY OF THE INVENTION

One embodiment of this invention relates to a spindle motor of a magnetic recording storage device, the spindle motor comprising a fluid dynamic bearing comprising a lubricant and an acrylate-containing compound as a freezing and/or pour point depressant additive for the lubricant. Preferably, the acrylate-containing compound is a polymer. Preferably, the acrylate-containing compound is a polymethyl acrylate-containing polymer. Preferably, the acrylate-containing compound reduces a pour point of the lubricant by at least 2 or 3° C. Preferably, the acrylate-containing compound depresses a pour point of the lubricant by at least 5° C. Preferably, the lubricant is an polyol ester-containing compound or polymer. Preferably, the lubricant is a mineral base hydro carbon, synthetic hydrocarbon containing compound, or an ester selected from the group consisting of diester, monoester, simple ester and compound ester. Preferably, the lubricant and the acrylate-containing compound exist as a single or multiple phase composition in the magnetic storage device.

Yet another embodiment of the invention relates to a method for depressing a freezing point of a spindle motor comprising obtaining the spindle motor of a magnetic recording storage device, the spindle motor comprising a fluid dynamic bearing, and depositing a lubricant and an acrylate-containing compound as a pour point depressant additive for the lubricant on the component. Additional advantages of this invention will become readily apparent to those skilled in this art from the following detailed description, wherein only the preferred embodiments of this invention is shown and described, simply by way of illustration of the best mode contemplated for carrying out this invention. As will be realized, this invention a property of other and different embodiments, and its details are capable of modifications in various obvious respects, all without departing from this invention. Accordingly, the drawings and description are to be regarded as illustrative in nature and not as restrictive.

### BRIEF DESCRIPTION OF THE DRAWINGS

The present invention will be better understood by reference to the Detailed Description of the Invention when taken together with the attached drawings, wherein:

FIG. 1 shows a magnetic recording medium.

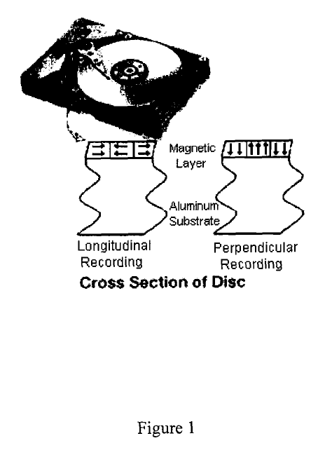

### DETAILED DESCRIPTION OF THE INVENTION

As used in the specification and claims, the singular forms “a”, “an” and “the” include plural references unless the context clearly dictates otherwise.

The term “freezing point” sometimes also referred as “pour point” relates to the lowest temperature at which an oil or other liquid will pour under given conditions. It is a rough indication of the lowest temperature at which the liquid is readily pumpable. Pour point is a very important property of the lubricant which determines the lowest operating temperature of the fluid flowing point. The number presented in the product data sheet regarding the pour point of any lubricant may be different than the actual pour point of that fluid. The variability comes from any or combination of these properties below: (1) lot variation; (2) the method of measurement; and (3) the duration of measurement.

The term “pour point reduction additive” refers to an additive that reduces the pour point of a liquid, thereby making the liquid flowable at a lower temperature than without the pour point depressant additive.

In the present invention, the method and duration of measurement of the pour were as follows: Very low temperature oven was used to do these experiments. Different samples of lubricants with different additives inside the vial (5-10 ml of sample) were placed inside the oven at particular set temperature (say −25° C.) for a set amount of duration (12-24 hrs).

The invention is directed to a lubricant for a disc drive and is referred in the specification to as a “lube.” Lubricants typically are liquid and contain molecular weight components that range from several hundred Daltons to several thousand Daltons.

While doing research in lubricants for disk drive spindle motors, the inventor encountered many lubricants which might have all the required properties to be applied in a spindle motor having a FDB but they were marginally acceptable for their high pour point. Hence, the goal of the present study was to see if there could be any reduction in pour point. The inventor unexpectedly found that the pour point of FDB lubricants can be lowered by adding special additives of polymethyl acrylate (PMA) type without harming the lubricant or the FDB.

Any lubricant to be used in hydrodynamic fluid bearing (storage devices) should have many important properties to have the maximum benefit. One of the properties is the lubricant freezing point or flowing point up to which the lubricant flows. It is well known fact that many lubricants with high and low viscosity range get frozen near or at −40° C. and some get frozen even at higher temperature. Even though those lubricants may have very good properties from viscosity, evaporation, viscosity index and/or compatibility point of view, but their application gets limited by the higher flowing point.

Hence, depending on the type of the molecular weight of the lubricant, the embodiments of the present invention lowers the freezing point of the lubricants for the FDB by adding a special chemical to the lubricant which will not effect the other lubricant properties significantly. One such chemical that was found to result in pour point depression is a polyacrylate or polymethyl acrylate (PMA) type additive. This additive usually has very a high molecular weight but based on its chemical characteristics, this additive can be added to the lubricant for the FDB of any type: mineral based hydrocarbon, synthetic hydrocarbon, esters etc. The effectiveness of the additive was found to be dependent on the type of chemical of the PMA type added to the lubricant and the nature of the lubricant.

The invention relates advanced ester related lubricants for fluid dynamic bearing of spindle motor for storage applications. It is well known in the art as how make ester relates lubricants such as polyol ester of chemical type neopentyl glycol dipelargonate.

In accordance with the present invention, the lubrication fluid could comprise a base fluid and optionally at least one additive other than the pour point reduction additive. Preferred base fluids include perfluoropolyethers (PFPEs), esters, synthetic hydrocarbons, and highly refined mineral hydrocarbons. Most preferred base fluids include diesters, short chain alcohol esters, polyol esters, and polyalphaolefins (PAO's). These base fluids can also be blended in a variety of combinations.

The additive could be selected, for example, so as to change the surface tension value at the gas-lubricant interface of the lubrication fluid. The additive could be at least partially soluble in the base fluid and have a low surface tension value compared to the base fluid. Additives that can be used with the present invention include polysiloxanes (silicones), polyacrelates, organic copolymars, and fluorocarbon compounds, such as PFPEs. Specific PFPEs that can be used with the present invention include FOMBLIN Z-DOL and FOMBLIN AM-2000, both commercially available from Ausimont, located in Morristown N.J. Z-DOL is a random copolymer of perfluorinated ethylene oxide and perfluorinated methylene oxide. AM-2000 is a difunctional aromatic terminated perfluoropolyether. Another additive that can be used with the present invention is VANLUBE DF 283, commercially available from RT Vanderbilt, located in Norwalk, Conn.

The surface tension of the lubrication fluid could be less than 35 dynes/cm, preferably in the range between 12 and 35 dynes/cm. For example, the surface tension of a typical base fluid (e.g., ester oil) is between 28 and 35 dynes/cm. The additive could cause the lubrication fluid to preferably have as surface tension lower than that of the base fluid alone. The additive could comprise between 0.02% and 2.0% by volume of the lubrication fluid.

In one example, the base fluid could comprise TMP ester or di-2-ethylhexl sebacic acid ester having a surface tension between 27 and 33 dynes/cm, and the additive could comprise silicone fluid having a surface tension between 20 and 22 dynes/cm. In another example, the base fluid could comprise TMP ester or di-2-ethylhexl sebacic acid ester having a surface tension between 27 and 33 dynes/cm, and the additive could comprise PFPE having a surface tension between 15 and 20 dynes/cm.

It is desirable that the lubricant has a relatively narrow molecular weight distribution of molecular components. In practice, the narrower the distribution the easier it will be to maintain a steady-state concentration of one or more components in the vapor. For example, if the highest and lowest molecular weight components in the polymer have very similar molecular weights, their vapor pressures will also be very similar. On the other hand, if the molecular weights (vapor pressures) are dramatically different heating of the lubricant will require much greater temperature and process control for a steady state concentration to be maintained. The lubricant used in the invention should have an M_{w}/Mₙ ratio between 1 and 1.6, preferably between 1 and 1.3, more preferably between 1 and 1.2.

The invention can be practiced with any commercial lubricant with a relatively large or small polydispersity, or with a lubricant that has been pre-fractionated to obtain a lubricant with a relatively small polydispersity. The preferred embodiment of the invention does not involve pre-fractionation of the lubricant. However, pre-fractionated lubricants may be used to provide relatively narrow molecular weight lubricant. If a pre-fractionated lubricant is used in the invention, distillation, chromatography, extraction, or other techniques that allow separation can obtain the pre-fractionated lubricant by molecular weight.

The freezing point or pour point reduction additives of the embodiments of the invention are alkylated aromatics, styrene esters, esters of Pthalic acid, poly acrylates or PMA type compounds and polyfumarates. For example, one of the additive is PMA. The other possible polyacrylates include polyalkyl methacrylate (PAMA), polyvinyl arylate, poly methyl acrylate, polybutyl acrylate, and many more. The molecular weight range can be as low as few hundreds to as high as 10 millions. The viscosity range could be 100 to 5000 cst@40° C. and 10 to 500 cst@100° C. and more preferably 500-1000 cst@40° C. and 50-150 cst@100° C. The freezing point rage could be from 0° C. to −40° C. more preferably from −5° C. to −30° C.

### EXAMPLES

The following samples were tested for freezing point reduction:

1. ST5L51 (control); this lubricant is a polyol ester of chemical type neopentyl glycol dipelargonate.

2. ST5L51+0.2% PMA

3. ST5L51+2.0% PMA

Sample sizes were roughly 10 ml in each cases. ST5L51 is a polyol ester and it had been chosen mainly for the experiment because of its higher pour point. Previous study shows that its pour point lies between −25 to −27° C.

The above 3 samples were placed in separate vials inside an oven and maintained at a fixed low temperature for certain durations. Test 1 and test 2 were done in two separate ovens. The test methodology for both Test 1 and 2 were the same. Only liquid behavior was checked for this study.

The results of the above tests are shown in Table 1.

TABLE 1

| Temperature* | Duration | | Result of Test 2 conducted in |
|---|---|---|---|
| (° C.) | (hours) | Result of Test 1 | different ovens |
| −10 | 4 | All samples are liquid | All samples are liquid |
| −20 | 16 | All samples are liquid | All samples are liquid |
| −25 | 16 | All samples are liquid | All samples are liquid |
| −27 | 24 | Sample 1 was frozen; | |
| | | Samples 2 and 3 were liquid | |
| −30 | 16 | Sample 1 and 2 were frozen; | Sample 1 was partly frozen; |
| | | Sample 3 was liquid | Samples 2 and 3 were liquid |
| −32 | 16 | Sample 3 was still liquid | Sample 1 was frozen; |
| | | | Samples 2 and 3 were liquid |
| −35 | 24 | Sample 3 was liquid for 3 | Sample 3 started to freeze |
| | | hours; frozen after 24 hours | |
| −37 | 24 | Samples 1-3 were frozen | Samples 1-3 were frozen |

*Shows oven temperature; actual temperature near the vials (by thermocouple) were about ˜1.8° C. higher.

All the experiments have been repeated twice. The observations and conclusions from the above experiments were the following:

(1) The freezing point of ST5L51 got lowered by at least an extra 3 degree and as much as by 5° C. with the addition of the pour point depressant additive such as a PMA polymer.

(2) The increased amount of the pour point depressant additive did not correlate linearly with the lowering of freezing point.

In this application, the word “containing” means that a material comprises the elements or compounds before the word “containing” but the material could still include other elements and compounds. This application discloses several numerical ranges in the text and figures. The numerical ranges disclosed inherently support any, range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

What is claimed is:

1. A spindle motor of a magnetic recording storage device, the spindle motor comprising a fluid dynamic bearing comprising a lubricant and an acrylate-containing compound as a freezing and/or pour point depressant additive for the lubricant.

2. The spindle motor of magnetic recording storage device of claim 1, wherein the acrylate-containing compound is a polymer.

3. The spindle motor of magnetic recording storage device of claim 1, wherein the acrylate-containing compound is a polymethyl acrylate-containing polymer.

4. The spindle motor of magnetic recording storage device of claim 1, wherein the acrylate-containing compound reduces a pour point of the lubricant by at least 2° C.

5. The spindle motor of magnetic recording storage device of claim 1, wherein the acrylate-containing compound depresses a pour point of the lubricant by at least 5° C.

6. The spindle motor of magnetic recording storage device of claim 1, wherein the lubricant is an polyol ester-containing compound or polymer.

7. The spindle motor of magnetic recording storage device of claim 1, wherein the lubricant is a mineral base hydro carbon, synthetic hydrocarbon containing compound, or an ester selected from the group consisting of diester, monoester, simple ester and compound ester.

8. The spindle motor of magnetic recording storage device of claim 1, wherein the lubricant and the acrylate-containing compound exist as a single phase composition.

9. The spindle motor of magnetic recording storage device of claim 1, wherein the lubricant and the acrylate-containing compound exist as a multiple phase composition.

10. A method for depressing a freezing point of a spindle motor comprising obtaining the spindle motor of a magnetic recording storage device, the spindle motor comprising a fluid dynamic bearing, and depositing a lubricant and an acrylate-containing compound as a pour point depressant additive for the lubricant on the component.

11. The method of claim 11, wherein the acrylate-containing compound is a polymer.

12. The method of claim 11, wherein the acrylate-containing compound is a polymethyl acrylate-containing polymer.

13. The method of claim 11, wherein the acrylate-containing compound depresses a pour point of the lubricant by at least 2° C.

14. The method of claim 11, wherein the acrylate-containing compound depresses a pour point of the lubricant by at least 5° C.

15. The method of claim 11, wherein the lubricant is an polyol ester-containing compound.

16. The method of claim 11, wherein the lubricant and the acrylate-containing compound exist as a single phase composition.
